(19) United States
(12) Patent Application Publication
(10) Pub. No.: US 2008/0111983 A1
(43) Pub. Date: May 15, 2008

(54) Illumination System for a Microlithographic Projection Exposure Apparatus

(75) Inventors: Wolfgang Singer, Aalen (DE); Dieter Bader, Obergroeningen (DE); Johannes Wangler, Koenigsbronn (DE); Markus Deguenther, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/813,529

(22) PCT Filed: Dec. 30, 2005
(86) PCT No.: PCT/EP05/14122

§ 371 Date: Oct. 3, 2007

Related U.S. Application Data
(60) Provisional application No. 60/644,057, filed on Jan. 14, 2005.

(51) Int. Cl. G03B 27/72

(52) U.S. Cl. 355/69

(57) ABSTRACT

An illumination system (12) of a microlithographic exposure system comprises a plurality of light emitting elements (24) that have light exit facets that are positioned in or in close proximity to a field plane (OP) or a pupil plane and are configured to be individually activated. Light collecting elements, for example microlenses of a fly-eye lens or arrays of cylinder lenses, may be used to collect the light bundles emitted by the light emitting elements (24). Homogenizing means, for example a rod integrator or an optical raster element (40), may be provided for improving the intensity uniformity in a reticle plane (RP).

### BACKGROUND OF THE INVENTION

1. Field of the Invention

The invention relates generally to illumination systems for microlithographic projection exposure apparatuses. More particularly, the invention relates to illumination systems having a light source that comprises a plurality of light emitting elements, for example light emitting diodes (LEDs) or laser diodes.

2. Description of Related Art

Microlithography (also called photolithography) is a technology for the fabrication of integrated circuits, liquid crystal displays and other microstructured components. The process of microlithography is, in conjunction with the process of etching, used to pattern features in thin film stacks that have been formed on a substrate, for example a silicon wafer. At each layer of the fabrication, the wafer is first coated with a photoresist which is a material that is sensitive to radiation, such as deep ultraviolet (DUV) light. Next, the wafer with the photoresist on top is exposed to projection light through a reticle (also referred to as a mask) in a projection exposure apparatus, such as a step-and-scan tool. The reticle contains a circuit pattern to be projected onto the photoresist. After exposure the photoresist is developed to produce an image corresponding to the circuit pattern contained in the reticle. Then an etch process transfers the circuit pattern into the thin film stacks on the wafer. Finally, the photoresist is removed.

A projection exposure apparatus typically includes an illumination system, a reticle alignment stage, a projection lens and a wafer alignment stage. The illumination system illuminates a region of the reticle with an illumination field that may have the shape of an elongated rectangular or curved slit. As the technology for manufacturing microstructured devices advances, there are ever increasing demands also on the illumination system. For example, there is a need to illuminate the reticle with an illumination field having a very uniform intensity.

Another important property of illumination systems is the ability to manipulate the angular distribution of the projection light bundle that is directed onto the reticle. In more sophisticated illumination systems it is possible to adapt the angular distribution of the projection light to the kind of pattern to be projected onto the reticle. For example, relatively large sized features may require a different angular distribution than small sized features. The most commonly used angular distributions of projection light are referred to as conventional, annular, dipole and quadrupole illumination settings. These terms refer to the intensity distribution in a pupil plane of the illumination system. With an annular illumination setting, for example, only an annular region is illuminated in the pupil plane, and thus there is only a small range of angles present in the angular distribution of the projection light so that all light beams impinge obliquely with similar angles onto the reticle.

Since the resolution of the projection lens is a linear function of the wavelength of the projection light, light sources are used in illumination systems that produce projection light having a very short wavelength. At present, the shortest wavelengths encountered in projection exposure apparatuses are 193 nm and 157 nm. For producing light having these wavelengths lasers are used. Since a laser produces a highly collimated projection light beam, considerable efforts have to be made to transform the collimated light beam into a projection light bundle having the desired uniformity and angular distribution. To this end, conventional illumination systems often comprise various optical raster elements that increase the divergence. Other means, for example rod integrators, are provided for homogenizing the intensity distribution on the reticle plane.

Another type of light source for an illumination system is disclosed in WO 2004/006021 which is assigned to the applicant and has been published on Jan. 15, 2004. The light source disclosed in this document comprises a plurality of small light emitting diodes (LEDs) that are arranged in a grid-like regular array. According to a preferred embodiment this array is arranged in a pupil plane of the illumination system. Since the light emitting diodes can be activated individually by a control unit, it is possible to produce almost any arbitrary illumination setting by selectively switching on and off individual light emitting diodes in the pupil plane.

### SUMMARY OF THE INVENTION

It is an object of the present invention to further improve an illumination system having a light source that comprises a plurality of light emitting elements.

According to a first aspect of the invention, this object is achieved by an illumination system of a microlithographic exposure apparatus for illuminating a structure, for example a pattern contained in a reticle, wherein said system comprises a plurality of light emitting elements that
a) have light exit facets that are positioned in or in close proximity to a field plane and
b) are configured to be individually activated.

By arranging the plurality of light emitting elements in an a field plane, it is possible to dispense with various optical elements that are conventionally required to produce secondary light sources from a primary light source such as a laser or a discharge lamp.

The field plane may be an object plane of an objective that conjugates the object plane to an image plane in which the structure is positioned during operation of the illumination system. In this context it should be noted that the terms “field plane”, “image plane” or “pupil plane” do not necessarily relate to planes in the strict geometrical sense, but may also denote curved surfaces.

The possibility to individually control the brightness of individual light emitting elements or to completely switch selected elements on or off further allows to achieve a very homogeneous intensity distribution in the reticle plane. Therefore homogenizers may, according to the demands on the intensity uniformity, be dispensed with, too.

A further advantage of having a plurality of light emitting elements in a field plane is the possibility to define the illuminated field on the reticle by selectively switching on and off individual light emitting elements.

For example, if the projection exposure apparatus is a step-and-scan tool and the light emitting elements are arranged in rows extending perpendicular to a scan direction, it is furthermore possible to selectively switch on and off complete rows of light emitting elements in a synchronized manner with the scan movement. This interesting property can, for example, be exploited at the beginning and the end of each exposure cycle when it has to be ensured that the extension of the illuminated field along the scan direction is changed in order to achieve a homogenous radiation dose on each point on the illuminated field on the photoresist. If these rows are arranged, along the scan direction, in a staggered manner, this improves the homogeneity of the intensity distribution within the illuminated field.

An adjustment of the shape of the illuminated field on the reticle may also be advantageous in view of lens heating effects. Due to the usually slit-like shape of the illuminated field, the optical elements contained in the illumination system and particularly in the projection lens are usually exposed to a light intensity distribution that is not rotationally symmetric with respect to the optical axis. This may result in deformations of the optical elements that are not rotationally symmetrical as well and are therefore difficult to compensate for.

The plurality of light emitting elements arranged in a field plane now allows to tilt the illuminated field on the reticle by 90° in regular intervals, for example after each exposure cycle, by simply activating a different set of light emitting elements. As a result, a more rotationally symmetric temperature distribution within the optical elements exposed to the projection light is achieved, and hence aberrations due to the non-rotationally symmetric deformations are reduced.

The illumination system may contain an optical integrator, for example an optical raster element that is positioned in or in close proximity to a pupil plane of the illumination system. Such a raster element usually comprises a plurality of optical members, as is described in U.S. Pat. No. 4,497,015 A whose full disclosure is incorporated herein by reference. If the illuminated field on the reticle has a rectangular geometry, the optical members may advantageously have, in a plane parallel to the pupil plane, a rectangular shape as well. In this case the light emitting elements may also be arranged in a regular rectangular array in order to ensure that the pupil is completely and homogenously filled with projection light.

Typically, the optical members are refractive optical members each having a convex front surface and a convex rear surface. The best integrating effect is achieved if the convex surface of each member images the entirety of the light emitting elements onto the rear surface. Such a configuration may be achieved, for example, if the optical integrator comprises a pair of fly-eye lenses. Alternatively, the raster element may comprise other structures that increase the geometrical optical flux of the projection light. For example, the raster element may be realized as a diffractive optical element.

Instead of an optical raster element, a rod integrator may be used that has a front facet and a rear facet which are each positioned in field planes of the illumination systems.

If light emitting diodes or laser diodes are used as light emitting elements, this has the advantage that these elements already produce, in contrast to conventional lasers, light having a substantial divergence. Therefore optical elements that introduce a divergence, may, at least partly, be dispensed with.

Particularly if light emitting diodes are used as light emitting elements, there may be even a need to reduce the divergence. To this end a plurality of light collecting elements may be provided that reduce the divergence of light emitted by the light emitting elements. Without such light collecting elements, a considerable portion of the light produced by the light emitting diodes would be absorbed by housing parts of the illumination system, or condenser lenses with vary large diameters would be required. The light collecting elements may reduce the divergence by a factor F>5 and preferably by a factor F≧10. 10.

The best collecting effect may be achieved if the light collecting elements are arranged in an array which is positioned immediately behind the light exit facets of the light emitting elements, for example within an axial distance of 30 mm, more preferably of 10 mm.

In one embodiment each light collecting element is associated with a single light emitting element. Such a configuration may be achieved, for example, by light collecting elements that are realized as micro lenses of a fly-eye lens. However, the light collecting elements may also be cylinder lenses that extend along orthogonal directions.

If the light emitting elements are arranged in a field plane, different angular distributions may be selected by inserting diaphragms in or in close proximity to a pupil plane of the illumination system. To this end, an exchange holder may be provided that allows to interchangeably introduce different diaphragms into the exchange holder.

According to a second aspect of the invention, the above mentioned object is achieved by an illumination system of a microlithographic exposure apparatus for illuminating a structure comprising a plurality of light emitting elements that
a) have light exit facets that are positioned in or in close proximity to a pupil plane and
b) are configured to be individually activated.

In the context of the present application, the term “close proximity” relates to a region in front of and behind the pupil plane in which the heights of the principal rays with respect to the optical axis is at least twice as large as the heights of the marginal rays. In illumination systems having typical dimensions, this corresponds to an axial distance in front of and behind the pupil plane of up to 30 mm.

Positioning the light emitting elements in or in close proximity to the pupil plane has the advantage that different angular distributions may simply be achieved by controlling the brightness and particularly by switching on and off individual light emitting elements. For example, if an annular illumination setting is desired, only those light emitting elements are activated that are positioned within a ring that is concentric to the optical axis. An adjustment of the annular illumination setting can simply be realized by changing the ring dimensions, i.e. by switching on and off light emitting elements that lie, at least approximately, on concentric circles.

Furthermore it is possible to correct various other optical properties, for example the telecentricity or ellipticity of light illuminating the structure, by carefully controlling the brightness of the individual light emitting elements.

If there are very severe requirements relating to the intensity uniformity in the reticle plane, an optical integrator may be used for homogenizing the light intensity distribution. Such an optical integrator may be realized as a rod integrator having a front facet and a rear facet that are each positioned in intermediate field planes.

The divergence of the light bundles emitted by the individual light emitting elements influences the geometry of the field which is illuminated on the reticle. Therefore an optical raster element positioned in or in close proximity to a further pupil plane may be used as an optical integrator. In this case the optical raster element may be designed such that the illuminated field on the reticle has the desired geometry.

Additionally or alternatively, a plurality of light collecting elements positioned immediately in front of the light emitting elements may be provided that reduce the divergence of light emitted by the light emitting elements. The light collecting elements may be designed such that the divergence of the light bundle produced by the individual light emitting elements is reduced to such an extent that the illuminated field has the desired geometry. Since the divergence of light emitting diodes or laser diodes is, at least approximately, rotationally symmetrical, anamorphic light collecting elements may be used if a rectangular or slit-like illuminated field on the structure is desired. The term “anamorphic” denotes the property of the elements to have different focal lengths in two orthogonal directions.

If each light emitting element is associated with only one refractive light collecting element in a one to one correspondence, such light collecting elements would require strongly aspherical surfaces if an anamorphic effect shall be achieved. A simpler approach may be to use a first array of cylinder lenses having longitudinal axes that are parallel to each other and that extend along a first direction. A second array of cylinder lenses have longitudinal axes that are parallel to each other and extend along a second direction which is orthogonal to the first direction. If the refractive powers of the cylinder lenses extending in orthogonal directions are different, this results in an anamorphic effect.

If different angular distributions of the projection light are achieved by either selectively activating individual light emitting elements or by using diaphragms in a conjugated pupil plane, the total light intensity within the illuminated field on the reticle will depend on the illumination setting. If the brightness of the light emitting elements is appropriately controlled by a control unit, it may be achieved that the light intensity remains constant irrespective of the illumination setting. In step-and-scan tools the same effect may be achieved if the scan velocity is appropriately adjusted. For example, if only a few light emitting elements are switched on, the scan velocity could be reduced in order to achieve the same illumination dose on the structure.

If at least one collecting element has an axis of symmetry that is laterally offset by a distance d with respect to an axis of symmetry of a light bundle emitted by a light emitting element, a tilt of the light bundle emitted by the light emitting element can be achieved very simply. By appropriately selecting the distances d for the collecting elements, it is possible to direct the individual light bundles onto a small area centered around the optical axis, for example a front facet of a rod integrator. Such a configuration therefore allows to dispense with additional condenser lenses.

A similar effect is achieved if the light emitting elements have light exit facets that are positioned tangentially with respect to a curved (imaginary), for example parabolically shaped, surface such that all light bundles emitted by the light emitting elements at least substantially superimpose on a given area. In this area the structure to be projected may be positioned, or this area may lie on the front facet of a rod integrator, for example.

The light emitting elements may also be realized as optical waveguides that are coupled to one or a plurality of light sources. For example, a conventional laser may used as light source, and optical fibers collect the light produced by the laser and distribute this light to different locations, for example in a field plane or a pupil plane. Alternatively, each optical waveguide may be coupled to a single light source, e.g. a light emitting diode or a laser diode.

### BRIEF DESCRIPTION OF THE DRAWINGS

Various features and advantages of the present invention may be more readily understood with reference to the following detailed description taken in conjunction with the accompanying drawing in which:

FIG. 1 is a simplified perspective view of a projection exposure apparatus;

FIG. 2 is a simplified meridional section of an illumination system having an array of LEDs in a field plane and comprising a fly-eye optical integrator;

FIG. 3 is a front view of the array of LEDs;

FIG. 4 shows a similar illumination system as illustrated in FIG. 2, but without a fly-eye integrator;

FIG. 5 shows an embodiment of an illumination system with an array of LEDs in a field plane and comprising a rod integrator;

FIG. 6 shows an embodiment of an illumination system without a condenser lens between the LEDs and a rod integrator;

FIG. 7 shows an embodiment of an illumination system in which LEDs are arranged on a curved surface;

FIG. 8 shows an embodiment in which LEDs are positioned in a pupil plane;

FIG. 9 shows a pair of cylinder lens arrays in a perspective view;

FIGS. 10a and 10b show a part of the illumination system of FIG. 8 in two orthogonal sections;

FIG. 11 shows an embodiment of an illumination system with LEDs in a pupil plane and comprising a fly-eye integrator;

FIG. 12 shows a simplified cross section through a panel on which LEDs are mounted;

FIG. 13 shows an alternative embodiment in which the light emitting elements comprise waveguides that are coupled to laser diodes.

### DESCRIPTION OF PREFERRED EMBODIMENTS

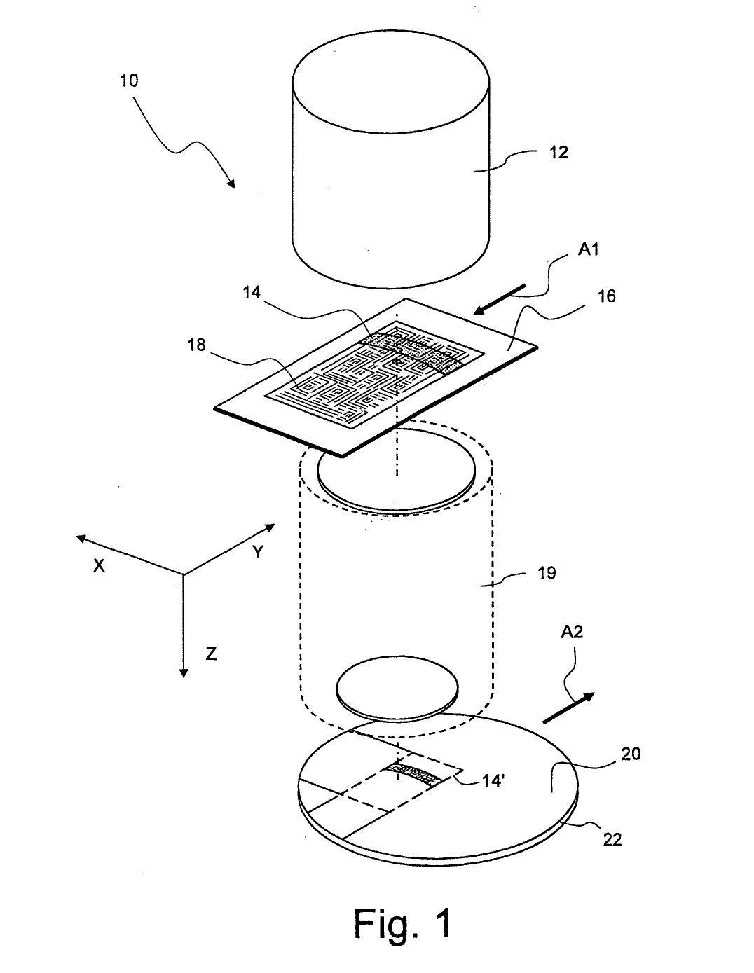

FIG. 1 shows a perspective and highly simplified view of an exemplary projection exposure apparatus in the accordance with the present invention. The projection exposure apparatus, which is denoted in its entirety by 10, comprises an illumination system 12 that produces a projection light bundle. The projection light bundle illuminates an elongated curved illuminated field 14 on a reticle 16 containing minute structures 18. The illuminated field 14 has, in the embodiment shown, approximately the shape of a ring segment. Other shapes, for example rectangular, are envisaged as well.

A projection lens 19 images the structures 18 within the illuminated field 14 onto a light sensitive layer 20, for example a photoresist, which is deposited on a substrate 22. The substrate, which may be realized as a silicon wafer, is arranged on a wafer stage in an image plane of the projection lens 19. The reticle 16 is positioned on a reticle stage in an object plane of the projection lens 19. Since the latter has a magnification of less than 1, a minified image 14′ of the structures 18 within the illuminated field 14 is projected onto the light sensitive layer 20.

During the projection, the reticle 16 and the substrate 22 are moved along a scan direction along the Y-direction. The ratio between the velocities of the reticle 16 and the substrate 22 is equal to the magnification of the projection lens 19. If the projection lens 19 inverts the image, the reticle 16 and the substrate 22 move in opposite directions, as this is indicated in FIG. 1 by arrows A1 and A2. Thus the illuminated field 14 scans over the reticle 16 such that structured areas on the reticle 16 can be continuously projected which are larger than the illuminated field 14. Such a type of projection exposure apparatus is usually referred to as a “step-and-scan tool” or briefly a “scanner”.

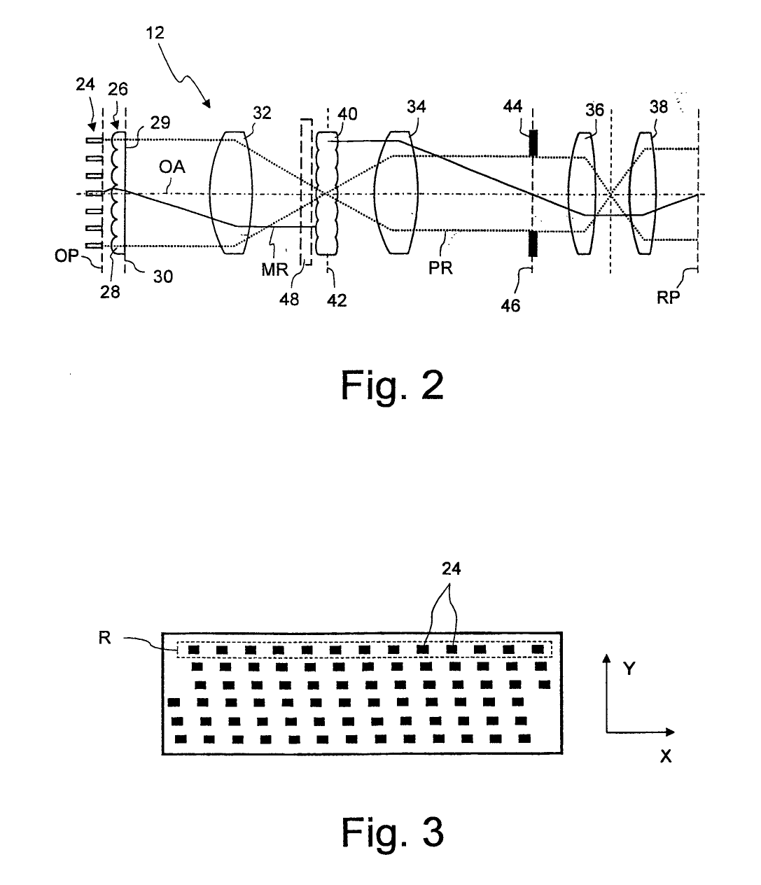

FIG. 2 shows a meridional section through the illumination system 12 in a simplified representation that is not to scale. This particularly implies that the function of optical sub-systems are generally represented by one optical element only. In real systems, these single lenses may be realized by complex optical sub-systems comprising diffractive structures and/or a plurality of positive and/or negative lenses that may have aspherical surfaces.

The illumination system 12 comprises a plurality of LEDs 24 that are arranged in a two-dimensional regular grid-like array and have light exit facets that are positioned in an object plane OP of the illumination system 12.

FIG. 3 shows a simplified front view of the light exit facets of the LEDs 24. The LEDs are distributed over a rectangular area and arranged in rows R with a constant spacing along the X direction. Along the Y direction, the rows R are slightly staggered. As a result of this staggered arrangement of the LEDs 24 in the Y direction, the overall radiation dose is constant to a very high degree for all points on the reticle 16 during the exposure cycle. By carefully controlling each individual LED 24, it is possible to achieve a very high intensity uniformity over the illuminated field 14 on the reticle.

The LEDs 24 emit radiation with a peak wavelength in the deep ultraviolet spectral range. The LEDs 24 are selected such that variations of the peak wavelengths are preferably below 1%. Each LED 24 produces a light bundle having an angular divergence that is in the order of approximately ±30°. The angular distribution of the light emitted by a single LED 24 is approximately constant. This means that the energy is evenly distributed over a cross section through the light bundle that runs perpendicular to an axis of symmetry.

For the sake of clarity, only a very small number of LEDs 24 are shown in FIGS. 2 and 3. In reality, however, the illumination system 12 may comprise several hundreds LEDs 24. In this embodiment about 700 LEDs 24 are distributed over the rectangular area that is shown in FIG. 3.

Immediately behind the LEDs 24 a fly-eye lens 26 is arranged. The fly-eye lens 26 comprises a plurality of microlenses 28 that are each associated to a single LED 24 in a one to one correspondence. The microlenses 28 have convex front surfaces and plane rear surfaces that lie in a common plane 30. The refractive power of the microlenses 28 and the distance between the microlenses 28 and the light exit facets of the LEDs 24 are selected such that the angular divergence of a light bundles produced by the LEDs 24 is reduced. Further, in the example shown in FIGS. 2 and 3, the refractive power of the microlenses 28 is determined such that the light exit facets of the LEDs 24 are imaged onto the rear surfaces. Thus the plane 30 is a first intermediate image plane on which the fly-eye lens 12 forms secondary magnified images of the light exit facets of the LEDs 24. Alternatively, the secondary magnified images of the light exit facets may be virtual and situated in front of the microlenses 28.

If there was no optical integrator 40, the first intermediate image plane 30 would be imaged by a first condenser lens 32, a second condenser lens 34 and two further lenses 36, 38 onto a reticle plane RP in which the reticle 16 is positioned during an exposure cycle. In this and the following drawings, continuous lines denoted by MR and dotted lines denoted by PR indicate marginal rays emerging from the optical axis OA and principal rays, respectively.

In the embodiment shown, an adjustable diaphragm 44 is positioned in a second intermediate image plane 46 of the illumination system 12. The diaphragm has the function of a field stop, i.e. it ensures sharp edges of the illuminated field in the reticle plane RP.

If the angular distribution of the projection light impinging onto the reticle plane RP shall be modified, additional diaphragms may be arranged in or in close proximity of a pupil plane of the illumination system 12, for example close to the first pupil plane 42. To this end an exchange holder 48 may be provided that allows to interchangeably receive different diaphragms.

In the embodiment shown, the optical integrator 40 is realized as a fly-eye integrator. The plane 30 is in a Fourier-relationship to plane 42. This may be achieved if the plane 30 is approximately the front Fourier plane of the lens 32 and the plane 42 is approximately positioned in the rear focal plane of the lens 32. Thus, in the rear image plane of each microlens contained in the fly-eye integrator 40 an image of the intensity distribution in the object plane OP, which is determined by the array of LEDs 24, is formed.

If the illuminated field 14 in the reticle plane RP has a high aspect ration, i.e. it has very different extensions along the X and the Y directions, the individual microlenses are frequently rectangular with a high aspect ratio. In conventional imaging systems with plasma light sources such as i-line lamps, this simple arrangement of the light source in a plane close to plane 30 is not possible. As shown e.g. in U.S. Pat. No. 5,636,003 A, cascaded fly-eye integrators are used to form an approximately rectangular distribution of images of the light source positioned in the plane 30. According to the invention, however, it is possible to arrange the LEDs 24 in a rectangular arrangement of high aspect ratio such that the image of the LEDs 24 fills the rear image plane of each fly eye lens at least 90%. Therefore the rectangular arrangement of the LEDs 24 as shown in FIG. 3 ensures that the pupil is homogeneously filled even if the illuminated field in the reticle plane RP has a high aspect ratio.

If the shape of the illuminated field in the reticle plane RP shall be modified, this can be achieved by simply switching on and off rows R of LEDs 24. If the light intensity shall remain constant irrespective of the actual shape of the illuminated field, the brightness of the LEDs 124 may be appropriately adjusted. For example, if the extension of the illuminated field 14 along the scan direction Y shall be reduced, the brightness of the LEDs 24 could be increased so that the scan velocity does not have to be decreased. Alternatively, the brightness of the LEDs 24 is kept constant and the scan velocity is reduced, or the brightness of the LEDs 24 is slightly increased and the scan velocity is slightly reduced.

In a preferred embodiment the extension of the illuminated field 14 along the scan direction (Y direction) is modified during the exposure cycle such that at the beginning of the exposure cycle the LEDs 24 are switched on row by row, while at the end of the exposure cycle the LEDs 24 are switched off row by row. Thus no adjustable diaphragms or blades for masking the illuminated field are required, and it is ensured that no area is exposed to projection light at the beginning and the end of the exposure cycle that should not be exposed.

In a further alternative embodiment, the optical integrator 40 may be formed by two individual fly-eye lenses that are closely spaced apart such that the back focal lengths of microlenses contained in the first fly-eye lense coincide with the rear surfaces of microlenses contained in the second fly-eye lens. Further examples for suitable optical integrators are described in more detail in U.S. Pat. No. 4,497,015 A, whose full contents is incorporated herein by reference.

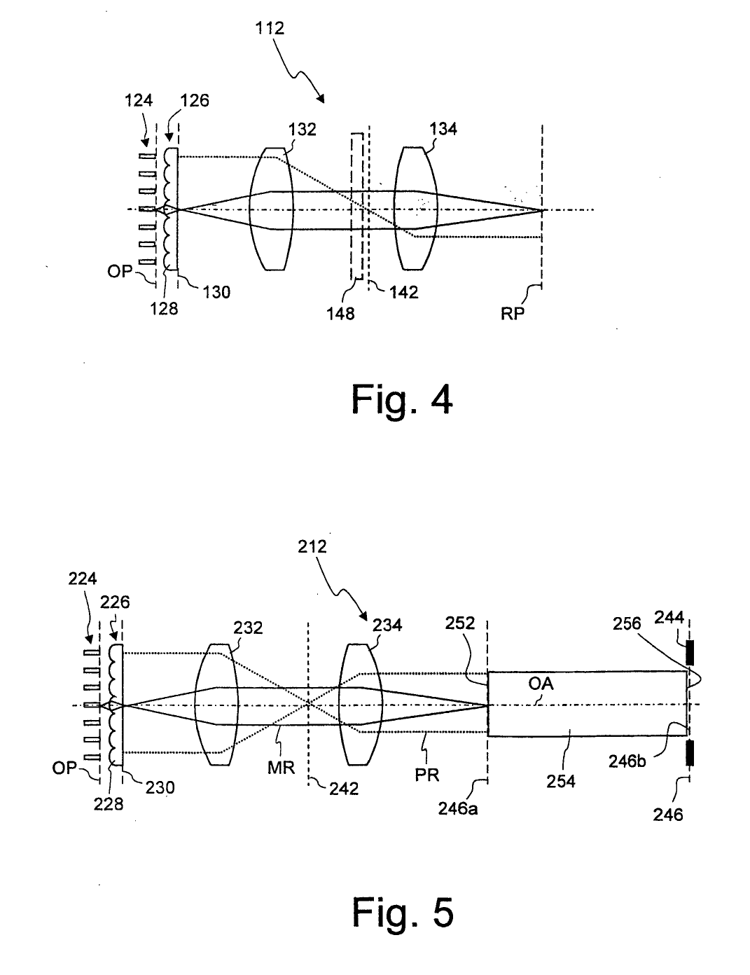

FIG. 4 shows another embodiment of an illumination system that has a particularly simple construction. Elements that have corresponding parts in the embodiment shown in FIG. 2 are denoted by reference numerals increased by 100 and may not be further explained again. The illumination system, which is denoted in its entirety by 112, corresponds to the illumination system 12 shown in FIG. 2 with the exception that no integrator 40 is positioned in the pupil plane 142 of the illumination system 112. Furthermore, no second intermediate image plane 46 is provided. Instead, the object plane OP is imaged directly by the two lenses 132, 134 onto the reticle plane RP. A constant radiation dose is achieved in this embodiment as a result of a scan movement of the reticle 16 with respect to the fixed array of LEDs 124 that is shown in FIG. 3.

Another approach to achieve a high intensity uniformity in the reticle plane RP is to use a rod integrator. This is illustrated in FIG. 5 showing a further embodiment of an illumination system in a similar representation as in FIG. 2. Elements that have corresponding parts in the embodiment shown in FIG. 2 are denoted by reference numerals increased by 200 and may not be further explained again. For the sake of simplicity, the lenses 36, 38 that image the diaphragm 44 onto the reticle plane RP are omitted.

In this embodiment two lenses 232, 234 image the object plane OP onto a first intermediate image plane 246a in which a front facet 252 of a rod integrator 254 is positioned. A rear facet 256 of the rod integrator 254 forms another field plane 246b in which the diaphragm 244 is arranged. Within the rod integrator 254, light entering the front facet 252 is mixed by multiple total reflections at the lateral surfaces of the rod integrator 254, as is known in the art as such. Different illumination settings may be generated by introducing different diaphragms in the pupil plane 242 between the lenses 232, 234.

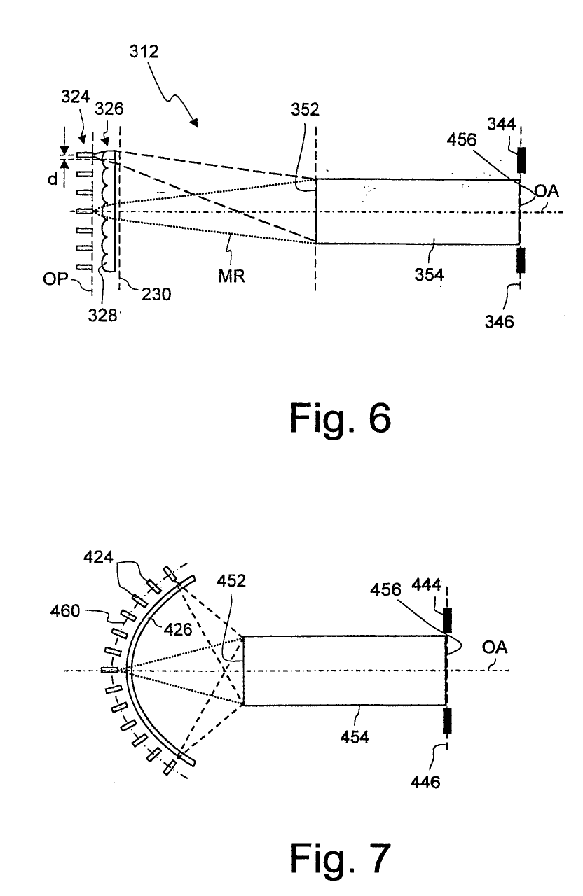

FIG. 6 shows an alternative embodiment of an illumination system that is denoted in its entirety by 312. Elements that have corresponding parts in the embodiment shown in FIG. 5 are denoted by reference numerals further increased by 100 and may not be further explained again. In the illumination system 312 an array of LEDs 324 directly illuminates a front facet 352 of a rod integrator 354. This means that there are no intermediate refractive optical elements that image the light exit facets of the LEDs 324 onto the front facet 352 of the rod integrator 354. In this embodiment most LEDs 324 have a lateral offset d with respect to an axis of symmetry 367 of the microlens 328 that is associated with the respective LED 324. This lateral offset d increases with growing distance between the LED 324 and the optical axis OA. Due to the lateral offset, the light bundles emitted by the LEDs 324 are tilted towards the optical axis OA and thus directed onto the front facet 352 of the rod integrator 354 without the need of an additional condensor lens. For the sake of simplicity, the lenses that image the diaphragm 344 onto the reticle plane RP are omitted.

FIG. 7 shows a part of an illumination system 412 according to another embodiment in which LEDs 424 are arranged along an imaginary concave surface 460 of approximately parabolical shape. Elements that have corresponding parts in the embodiment shown in FIG. 5 are denoted by reference numerals increased by 200 and may not be further explained again. The LEDs 424 are positioned along the surface 460 such that their light exit facets are aligned tangentially to the surface 460. A thin flexible foil 426 containing a plurality of diffractive optical elements is positioned in front of the light exit facets of the LEDs 424. The diffractive optical elements collect the light bundles emitted by the LEDs 424 and direct them onto the front facet 452 of the rod integrator 454. As a result of this non-planar arrangement of the LEDs 424, there is neither a condenser lens nor is there any need to tilt the light bundles emitted by the LEDs 424 so that the diffractive optical elements may be centered with respect to the individual light bundles.

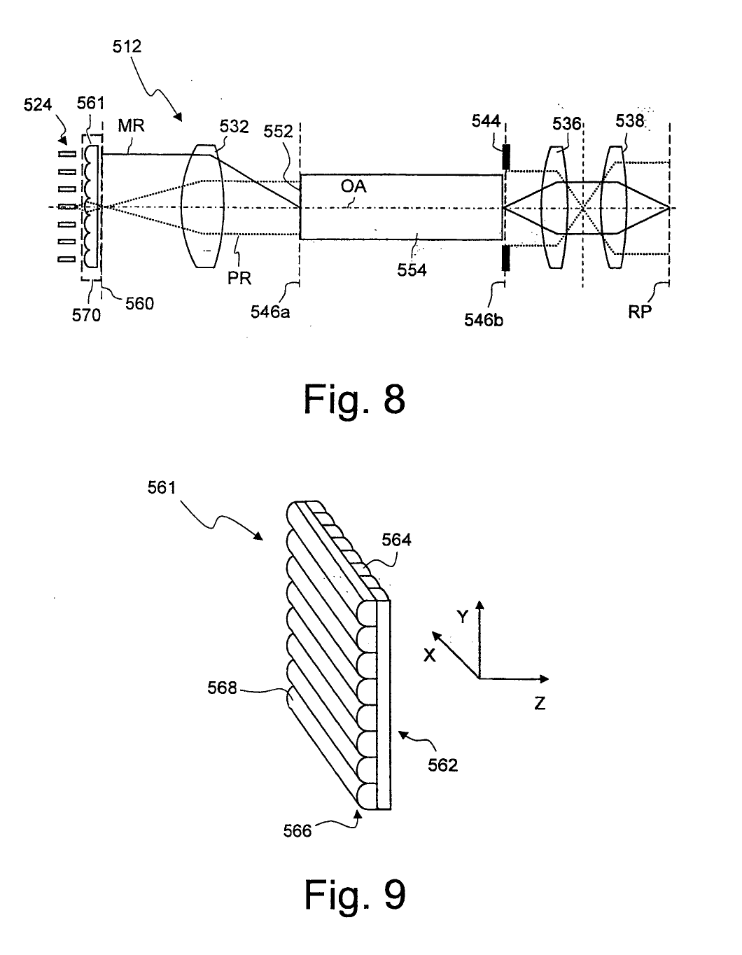

FIG. 8 shows an embodiment of an illumination system denoted by 512 in which LEDs 524 are positioned in or in close proximity to a pupil plane 560 of the illumination system 512. Elements that have corresponding parts in the embodiment shown in FIG. 2 are denoted by reference numerals increased by 500 and may not be further explained again. For reducing the divergence of the light bundles emitted by the LEDs 524, a pair 561 of cylinder lens arrays is positioned between the light exit facets of the LEDs 524 and the pupil plane 560. The pair 561 of cylinder lens arrays images the light exit facets of the LEDs 524 onto the pupil plane 560.

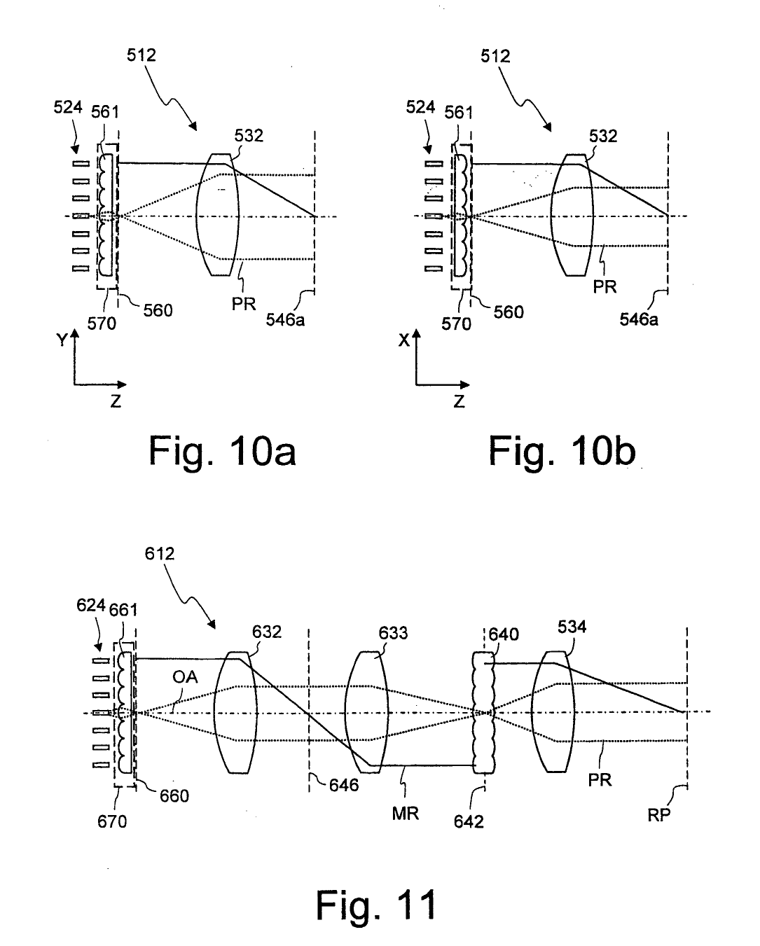

FIG. 9 shows the pair 561 of cylinder lens arrays in a perspective view. A first array 562 comprises cylinder lenses 564 that have longitudinal axes extending along the Y direction and having rear surfaces with a radius R1. A second array 566 comprises cylinder lenses 568 that have longitudinal axes extending along the X direction and having rear surfaces with a radius R2>R1. As a result of the different refractive powers in the X and Y directions, the pair 561 of cylinder lens arrays 562, 566 is anamorphic, i.e. the focal lengths are different in the X and Y direction. Therefore the divergences of the light bundles propagating through the pupil plane 560 are different in the X and Y direction. Since angles in a pupil plane translate into locations in a field plane and vice versa, the anamorphic effect of the pair 561 of cylinder lens arrays produces approximately a rectangular illuminated field in the reticle plane RP. This is also illustrated in FIGS. 10a and 10b that show meridional sections through the illumination system 512 in the Y-Z plane and the X-Z plane, respectively.

The light emerging from the pair 561 of cylinder lens arrays 562, 566 is collected by a condenser lens 532 and is directed to a front facet 552 of a rod integrator 554, wherein the front facet 552 is positioned in a field plane 546. The remaining components of the illumination system 512 correspond to the embodiment shown in FIG. 5.

Since the LEDs 524 are arranged in or in close proximity to a pupil plane, it is possible to determine the angular distribution of the projection light impinging on the reticle plane RP by individually controlling the brightness of the LEDs 524. The geometry of the illuminated field in the reticle plane RP can be adjusted by modifying the refractive power of the cylinder lens arrays 562, 566. The simplest way to change the refractive power is to replace one or both arrays 562, 566 by other arrays having cylinder lenses with different curvatures. To this end the pair 561 of cylinder lens arrays may be received in an exchange holder 570.

If the light intensity distribution in the field plane 546 is sufficiently homogenous, the rod integrator 554 may be dispensed with. The reticle 16 is then positioned immediately in the field plane 546. A gray filter or a variable uniformity filter may then be used for improving the intensity uniformity. Such a filter should be positioned close to the reticle plane or a field plane conjugated thereto. Further details of variable uniformity filters are disclosed in EP 0 952 491 A2.

FIG. 11 shows an alternative embodiment of an illumination system which is denoted in its entirety by 612. Elements that have corresponding parts in the embodiment shown in FIG. 10 are denoted by reference numerals further increased by 100 and may not be further explained again. The illumination system 612 differs from the illumination system 512 shown in FIG. 8 in that a fly-eye lens integrator 640 is used for homogenizing the projection light instead of a rod integrator 554. Since the integrator 640 has to be positioned in or in close proximity to a pupil plane, an additional lens 633 is provided that produces a Fourier transform relationship between the field plane 646 and the pupil plane 642 in which the integrator 640 is positioned. The geometry of the illuminated field 14 on the reticle 16 is determined by the pair 661 of cylinder lens arrays and the integrator 640 that is positioned in the conjugated pupil plane 642.

Instead of positioning the reticle 16 in the field plane behind the collecting lens 634, a diaphragm may be provided in this field plane that is imaged by a further objective onto the reticle plane in a manner similar to what is shown in FIG. 2.

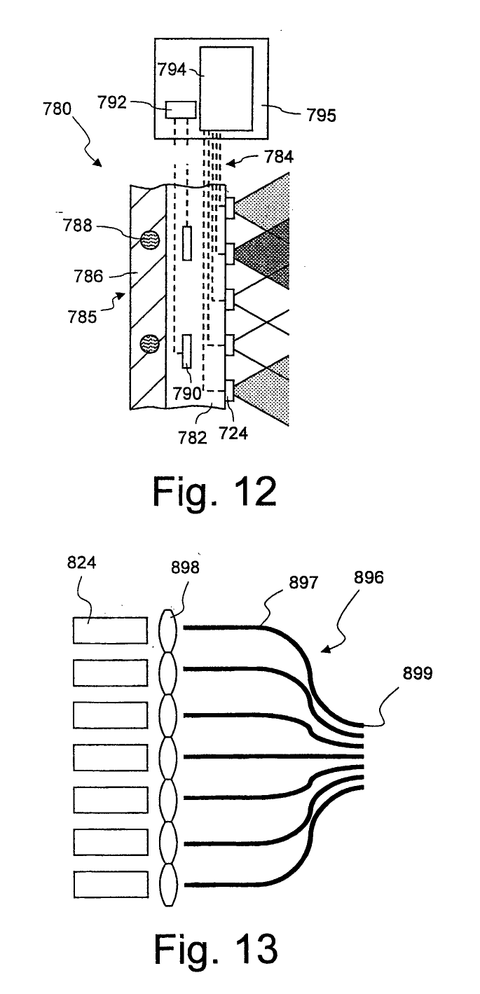

FIG. 12 shows a simplified enlarged section through a panel 780 on which LEDs 724 are mounted in a grid-like manner, for example the configuration shown in FIG. 3. The panel 780 comprises a board 782 that supports the LEDs 724 and the electrical wiring which is, for the sake of clarity, schematically indicated within the board and denoted by 784. The board 782 may be an aluminum coated circuit board or may be made of ceramics having a high temperature conductivity, for example. Since the densely packed LEDs 724 produce a considerable amount of heat, which may be as high as 200 W to 400 W, a liquid cooling system 785 is attached to the rear surface of the board 782. In the embodiment shown this cooling system comprises an aluminum plate 786 in which channels 788 for a cooling medium, e.g. water, are embedded.

Since the peak wavelength of the LEDs 724 is sensitive to temperature variations (up to 3 nm/° C.), temperature sensors 790 are embedded in the board 782 in the immediate vicinity of the LEDs 724. The temperature sensors 790 are part of a temperature control loop that ensures a constant temperature in the vicinity of the LEDs 724 by controlling the cooling effect provided by the liquid in the channels 788.

If the peak wavelength of the LED 724 cannot be reliably stabilized in this manner, an additional wavelength filter may be used for restricting the bandwidth of the LEDs 724. If the light intensity of projection light having traversed the wavelength filter is monitored by a light intensity sensor, it is possible to adjust the brightness of the LEDs 724 in such a way that a constant light intensity is achieved irrespective of possible variations of the peak wavelengths of the LEDs 724. Additionally or alternatively the cooling effect provided by the cooling system may be controlled such that the peak wavelength of the LEDs 724 is shifted. To this end, it may be advantageous to combine a controller 792 for the cooling system 785 with a brightness controller 794 in a common control unit 795. The brightness controller 794 allows to individually control the brightness of each individual LED 724. This is schematically indicated in FIG. 12 by different shadings that represent the brightness of light bundles produced by the LEDs 724.

The brightness controller 794, which is connected to the LEDs 724 via the electrical wiring 784, preferably controls the brightness of the LEDs 724 by providing a constant electrical current. This allows to meet the ideal operating point of the LEDs 724 much more precisely than it is possible with a constant voltage source.

An efficient cooling system is advantageous also in view of the working life of the LEDs 724. Typically, the working life of a LED 724 is in the order of 100 000 hours. However, the working life is strongly dependent on the operating conditions and in particular on the operating temperature. Apart from that, the brightness usually decreases, during the working time, by about 50%. For that reason it may be advantageous to control the LEDs 724 such that they never produce their maximum brightness but only a reduced brightness, for example 80% of the maximum value. This ensures that a constant brightness can be maintained for a longer time period.

Since the working life of the LEDs 724 is a statistical value, some LEDs 724 will break down before they reach their mean working life. In order to compensate for a broken LED 724, either redundant LEDs may be provided that take over the function of the broken LED, or the broken LED has to be replaced by a new LED. To this end it may be advantageous to mount the LEDs 724 using exchangeable pedestals.

FIG. 13 shows a light source 896 for an illumination system according to an alternative embodiment in which the light emitting elements comprise monomode optical fibers 897 that are optically coupled via microlenses 898 to laser diodes 824. Instead of optical fibers 897 other optical waveguides, for example ridge waveguides that are applied to a substrate, may be used. Light exit facets 899 of the optical fibers 897 are arranged in the desired position within the illumination system, for example in or in close proximity to a field plane or a pupil plane. The light exit facets 899 thus correspond to the light exit facets of the LEDs shown in the embodiments described above.

Using optical fibers 897 allows to arrange the laser diodes 824 further away from the location where light shall exit the light exit facets 899, and thus a larger spacing between the laser diodes 824 becomes possible. This considerably simplifies the cooling of the laser diodes 824. Apart from that, optical fibers 897 may be, at least to a certain degree, bent. This facilitates the arrangement of light exit facets in spacially complex configurations such as shown, for example, in FIG. 7.

Since laser diodes 824 display stronger coherence effects than LEDs, additional means for reducing the coherence length, for example rotating scattering plates, may be employed. Additionally or alternatively, an electromagnetic coupling of light between adjacent laser diodes may be prevented, for example by depositing anti-reflection coatings on the lateral sides of the laser diodes. Each laser diodes 824 will then independently emit radiation such that the superposition of several hundreds or even thousands of single laser diodes results in a at least approximately incoherent radiation.

1. A system, comprising:
a microlithography illumination system comprising a plurality of light emitting elements that
a) have light exit facets that are positioned in or in close proximity to a field plane (OP), and
b) are configured to be individually activated, wherein the system is a microlithography illumination system.

2. The system of claim 1, wherein the field plane is an object plane (OP) of an objective that conjugates the object plane (OP) to an image plane (RP) in which a structure to be illuminated by the microlithography illumination system is positioned during operation of the microlithography illumination system.

3. The system of claim 1, further comprising a control unit configured to individually control the light emitting elements.

4. The system of claim 3, wherein the control unit is configured to activate the light emitting elements depending on the desired geometry of an illuminated field that is produced by the illumination system on the structure.

5. The system of claim 1, further comprising an optical integrator.

6. The system of claim 5, wherein the optical integrator is an optical raster element that is positioned in or in close proximity to a pupil plane.

7. The system of claim 6, wherein the optical raster element comprises a plurality of optical members.

8. The system of claim 7, wherein the optical members have, in a plane parallel to the pupil plane, a rectangular shape.

9. The system of claim 6, wherein the optical members are refractive optical members each having a convex front surface and a convex rear surface.

10. The system of claim 9, wherein the convex surface of each member images the plurality of light emitting elements onto the rear surface.

11. The system of claim 6, wherein the optical integrator comprises a pair of fly-eye lenses.

12. The system of claim 6, wherein the raster element is a diffractive optical element.

13. The system of claim 5, wherein the optical integrator is a rod integrator having a front facet and a rear facet that each are positioned in intermediate field planes of the illumination system.

14. The system of claim 1, further comprising a plurality of light collecting elements that reduce the divergence of light emitted by the light emitting elements.

15. The system of claim 14, wherein the light collecting elements reduce the divergence by a factor F>5.

16. The system of claim 15, wherein the light collecting elements reduce the divergence by a factor F≧10.

17. The system of claim 14, wherein the light collecting elements are arranged in an array which is positioned immediately behind the light exit facets of the light emitting elements.

18. The system of claim 14, wherein each light collecting element is associated with a single light emitting element.

19. The system of claim 14, wherein the light collecting elements are microlenses of a fly-eye lens.

20. The system of claim 1, wherein the microlithography illumination system produces an elongated illuminated field (14) having shorter dimensions along a scan direction (Y).

21. The system of claim 20, wherein the light emitting elements are arranged in a regular rectangular array.

22. The system of claim 20, wherein the light emitting elements are regularly spaced apart along a direction (X) that is perpendicular to the scan direction (Y).

23. The system of claim 22, wherein the light emitting elements are, in the scan direction (Y), arranged in a staggered manner.

24. The system of claim 1, further comprising an exchange holder configured to receive diaphragms that is positioned in or in close proximity to a pupil plane of the illumination system.

25. A system, comprising:
a microlithography illumination system comprising a plurality of light emitting elements that
a) have light exit facets that are positioned in or in close proximity to a pupil plane, and
b) are configured to be individually activated.

26. The system of claim 25, further comprising an optical integrator.

27. The system of claim 26, wherein the optical integrator is a rod integrator having a front facet and a rear facet that each are positioned in intermediate field planes.

28. The system of claim 26, wherein the optical integrator is an optical raster element that is positioned in or in close proximity to a further pupil plane.

29. The system of claim 25, further comprising a plurality of light collecting elements that reduce the divergence of light emitted by the light emitting elements.

30. The system of claim 29, wherein the light collecting elements are arranged as an array which is positioned behind the light emitting elements.

31. The system of claim 30, wherein each light collecting element is associated with a single light emitting element.

32. The system of claim 31, wherein the light collecting elements are microlenses of a fly-eye lens.

33. The system of claim 28, wherein the light collecting elements are anamorphic.

34. The system of claim 29, comprising:
a) a first array of cylinder lenses having a first refractive power and longitudinal axes that are parallel to each other and extend along a first direction (Y), and
b) a second array of cylinder lenses having a second refractive power distinct from the first refractive power and longitudinal axes that are parallel to each other and extend along a second direction (X) which is orthogonal to the first direction (Y).

35. The system of claim 12, wherein at least one collecting element has an axis of symmetry that is laterally offset by a distance d with respect to an axis of symmetry of a light bundle that is collected by the at least one collecting element.

36. The system of claim 35, wherein the distance d increases the further the axis of symmetry of the light bundle is spaced apart from an optical axis (OA) of the microlithography illumination system.

37. The system of claim 29, comprising an exchange holder configured to interchangeably receive different sets of light collecting elements.

38. The system of claim 25, further comprising a control unit configured to control the light emitting elements.

39. The system of claim 38, wherein the control unit is configured to control the brightness of the light emitting elements depending on a desired ellipticity of light illuminating the structure.

40. The system of claim 38, wherein the control unit is configured to control the brightness of the light emitting elements depending on an desired angular intensity distribution of light illuminating the structure.

41. The system of claim 38, wherein the control unit is configured to control the brightness of the light emitting elements depending on an input signal that is characteristic of the velocity of a reticle along a scan direction (Y).

42. A system, comprising: a microlithography illumination system comprising a plurality of light emitting elements having light exit facets that are positioned tangentially along a curved surface such that all light bundles emitted by the light emitting elements at least substantially superimpose on an optical element.

43. The system of claim 42, wherein the optical element is a rod integrator.

44. The system of claim 1, wherein at least one light emitting elements is a light emitting diode.

45. The system of claim 1, wherein at least one light emitting elements is a laser diode.

46. The system of claim 1, wherein at least one light emitting element is an optical waveguide that is coupled to a light source.

47. The system of claim 46, wherein at least two light emitting elements are optical waveguides that are each coupled to an individual light source.

48. The illumination system of claim 46, wherein at least two light emitting elements are optical waveguides that are coupled to a common light source.

49. The system of claim 1, wherein the light emitting elements are spaced apart by at least 4 mm.

50. The system of claim 49, wherein the light emitting elements are spaced apart by at least 8 mm.

51. The illumination system of claim 1, further comprising a cooling system configured to cool the light emitting elements.

52. The illumination system of claim 51, wherein the cooling system uses a liquid as cooling medium.

53. The illumination system of claim 51, wherein the cooling system comprises a control loop that ensures a constant temperature of the light emitting elements.
